(19) United States
(12) Patent Application Publication
(10) Pub. No.: US 2015/0033947 A1
(43) Pub. Date: Feb. 5, 2015

(54) APPLIANCE WHICH IS SUITABLE TO BE USED FOR MAKING A BEVERAGE IN AT LEAST TWO DIFFERENT WAYS

(71) Applicant: KONINKLIJKE PHILIPS N.V., EINDHOVEN (NL)

(72) Inventors: Gertrude Riëtte Van Der Kamp, Eindhoven (NL); Klaas Kooijker, Eindhoven (NL); Bernardo Arnoldus Mulder, Eindhoven (NL)

(21) Appl. No.: 14/383,286

(22) PCT Filed: Feb. 20, 2013
(86) PCT No.: PCT/IB2013/051373

§ 371 Date: Sep. 5, 2014

Related U.S. Application Data
(60) Provisional application No. 61/608,713, filed on Mar. 9, 2012.

(51) Int. Cl. A47J 31/46; A47J 31/56

(52) U.S. Cl. CPC A47J 31/46; A47J 31/56
USPC 99/283; 99/284

(57) ABSTRACT

An appliance (1) which can be used for making a beverage in at least two different ways comprises at least two different types of removable accessories, a housing (43) having an internal space for receiving and accommodating one of the accessories at a time, and a liquid supplying system for supplying a liquid to the internal space. In a practical embodiment of both types of accessories, a substantial portion of the accessory is generally shaped like a dish, wherein the dish-shaped portion of a first type of accessory comprises at least one hole for allowing liquid to pass that portion and flow from one side of that portion to the other, and wherein the dish-shaped portion of a second type of accessory is free from holes. The second type of accessory can therefore be used for guiding liquid received from the supplying system directly to outside of the appliance (1).

### FIELD OF THE INVENTION

The present invention relates to an appliance which is suitable to be used for making a beverage in at least two different ways, comprising at least two different types of removable accessories, a housing having an internal space for receiving and accommodating one of the accessories at a time, and a liquid supplying system for supplying a liquid to the internal space.

### BACKGROUND OF THE INVENTION

An appliance which is suitable to be used for making a beverage in at least two different ways is known from US 2007/107604. The appliance comprises at least two accessories, including an accessory which is to be used for brewing espresso coffee and an accessory which is to be used for brewing drip filter coffee. The accessories are interchangeable, and each can be loaded in an internal space of a housing of the appliance, which serves as a brewing room, in order to form an individual brewing chamber. The appliance further comprises a control circuit including a detection circuit for the accessory. By a water distributor assembly and the control circuit, a water flow of suitable pressure is provided into the brewing chamber, and the accessory in use is detected automatically so as to initiate a corresponding work mode according to desire. Preferably, two kinds of water flow of different pressures can be generated within the appliance, wherein one kind of water flow is of a relatively low pressure for brewing drip filter coffee, and wherein another kind of water flow is of a relatively high pressure for brewing espresso coffee.

The brewing room of the appliance can accommodate coffee capsules of various shapes or specifications, coffee pods of various shapes or specifications, or coffee powder of various amounts or specifications. The brewing room includes an espresso water inlet and a drip water inlet. For the purpose of selecting one of two appropriate work modes, the appliance comprises an espresso coffee control lever and a drip filter coffee control lever which are arranged in parallel. When the espresso coffee accessory is loaded, the espresso coffee control lever is pushed down, while the drip filter coffee control lever remains at the original position. When the drip filter coffee accessory is loaded, the drip filter coffee control lever is pushed down, while the espresso coffee control lever remains at the original position.

Both accessories comprise a dish-shaped portion with a filter plate at the bottom for supporting a coffee capsule, a coffee pod, or coffee powder. Furthermore, the accessories comprise a water discharge plug which is installed under the filter plate. During operation of the appliance with one of the accessories put in place inside the internal space of the housing of the appliance, water is pumped towards the brewing chamber, at an appropriate pressure, and heated by an electric heater. Inside the brewing chamber, the coffee is obtained on the basis of an interaction between the hot water and the coffee capsule, coffee pod, or coffee powder.

The basic construction of the two accessories is more or less the same. In particular, a path followed by water through the brewing chamber and through the accessories when the appliance is operated is more or less the same for both accessories. In fact, the capability of the appliance to make at least two different types of beverages is only based on the possibility of having at least two kinds of water flow of different pressures.

### SUMMARY OF THE INVENTION

It is an object of the present invention to provide an appliance which is suitable to be used for making a beverage in at least two different ways, namely by using at least one coffee pod which is placed inside the internal space of the housing of the appliance, or by supplying hot water to a conventional drip filter filled with coffee, which drip filter is placed outside of the internal space, and can be positioned on top of a jug, for example. In other words, it is desirable for the appliance to offer a user the possibility of making drip filter coffee in a traditional way besides the possibility of making pod-based coffee. The appliance known from US 2007/107604 is only suitable for making coffee by forcing water to flow through a brewing chamber for accommodating a suitable quantity of coffee extract, regardless of which accessory is used.

The object of the present invention is achieved by providing an appliance which is suitable to be used for making a beverage in at least two different ways, comprising at least two different types of removable accessories, a housing having an internal space for receiving and accommodating one of the accessories at a time, and a liquid supplying system for supplying a liquid to the internal space, wherein a first type of accessory is adapted to let the liquid pass from a side of the accessory at which the liquid is received from the liquid supplying system when the accessory is put in place inside the internal space to another side of the accessory before exiting the internal space, and wherein a second type of accessory is adapted to let the liquid follow a shorter path through the internal space before exiting the internal space.

Like the known appliance, the appliance according to the invention comprises at least two different types of removable accessories. In the following, a further explanation of the appliance according to the invention is given, wherein it is assumed that the beverage is coffee and that the liquid which is supplied to the internal space is hot water. For sake of completeness, it is noted that the liquid supplying system may comprise a container for containing the liquid and tubing extending from the container to the internal space.

A first type of accessory, which will hereinafter be referred to as flow through accessory, is adapted to let the hot water pass from a side of the accessory at which the hot water is received from the liquid supplying system when the accessory is put in place inside the internal space to another side of the accessory before exiting the internal space. Therefore, the flow through accessory is suitable to be used in a process in which hot water is forced to flow through a suitable quantity of coffee extract, which may be contained in a capsule or a pod, for example, wherein a certain pressure is applied by means of a pump or the like, and wherein the flow through accessory serves for supporting the quantity of coffee extract inside the internal space of the housing of the appliance. The hot water is supplied to the coffee extract, and the coffee which is obtained on the basis of the interaction between the water and the coffee extract passes the flow through accessory and reaches an exit of the internal space at another side of the flow through accessory than a side where the coffee extract is present and where the hot water is received from the liquid supplying system.

A second type of accessory is adapted to let the hot water follow a shorter path through the internal space before exiting the internal space than when the first type of accessory as described in the foregoing is applied. This type of accessory, which will hereinafter be referred to as closed accessory, is not known from the art. According to the invention, the closed accessory is suitable to be used in a process of making drip filter coffee. When the accessory is put in place inside the internal space of the housing of the appliance, it receives hot water from the liquid supplying system. The design of the closed accessory can be aimed at not allowing the water to flow from one side of the accessory to the other, so that the water remains at the one side. In this way, the water is made to flow almost directly out of the internal space, and the closed accessory functions as a kind of by-pass element in a situation in which there is no need for forcing water to flow through a quantity of coffee extract inside the internal space, at a certain pressure. In any case, when the closed accessory is used, the water can be directed directly to an outlet, wherein the path of the water through the internal space can be as short as possible. Hence, it is possible for the appliance to serve as a supplier of the hot water which is otherwise used for making coffee inside the appliance. On the basis of this fact, the appliance can be used in a process of making drip filter coffee. In that case, a combination of a drip filter holder for accommodating a drip filter filled with a quantity of coffee powder and a receptacle such as a jug positioned underneath the drip filter holder is used with the appliance.

It follows from the foregoing that the flow through accessory is suitable to be used in a process of making coffee in which a brewing process, i.e. a process during which hot water and coffee extract interact with each other, takes place in the internal space of the appliance. On the other hand, the closed accessory is suitable to be used in a process of making coffee in which a brewing process takes place outside of the appliance. When the closed accessory is used, the appliance serves for supplying hot water, which can be used for having a brewing process inside a drip filter filled with coffee powder.

For the purpose of displacing water through the appliance, the appliance is equipped with a pump or the like. In general, in case of an internal brewing process, a higher pressure is needed than in case of an external brewing process. Therefore, realizing a certain kind of brewing process by means of the appliance is not just a matter of choosing an appropriate accessory. Among other things, it is also important that the pump is operated in a certain way in order to realize an appropriate pressure.

In general, an advantage of the fact that the appliance can be used for various coffee making processes, particularly a process during which coffee is made inside the appliance with the help of a pod or capsule, for example, and a process during which coffee is made outside the appliance with the help of a drip filter, is that a user has an opportunity to adjust the operation of the appliance to an actual situation in which people would like to have coffee. When only a few people need to be served, a user may choose in favor of the internal brewing process, which yields a limited quantity of coffee during one time, by means of which only a limited number of cups, such as one or two cups, can be filled. However, when an actual group of people needs to be served, a user may choose in favor of the external brewing process, which yields a significantly larger quantity of coffee during one time, without the need for a user to be busy with the appliance in the meantime. If the user would try to serve a group of people with coffee made by means of the internal brewing process, he/she would need to be very active with removing the flow through accessory, removing used coffee pods, putting new pods in place on the accessory, putting the accessory back in place in the appliance, putting receptacles such as cups in place, pushing a button or the like for activating the appliance, etc., every time that new receptacles need to be filled.

The appliance offers the possibility of choosing between a process in which a single, relatively large receptacle such as a jug can be filled in one go, or a process in which a limited number of relatively small receptacles such as cups can be filled in one go. In other words, the appliance offers the possibility of choosing between a drip filter process and a cup-by-cup process. In the first case, the process takes more time, but this is not so much of a problem, as the user of the appliance does not need to stay with the appliance throughout the process.

According to a practical possibility, it is true for both types of accessories that a substantial portion of the accessory is generally shaped like a dish, wherein the dish-shaped portion of the flow through accessory comprises at least one hole for allowing liquid to pass the dish-shaped portion and flow from one side of the dish-shaped portion to the other, and wherein the dish-shaped portion of the closed accessory is free from holes. In the flow through accessory, the dish-shaped portion is suitable to be used for supporting the coffee extract. When the accessory is put in place inside the internal space of the housing of the appliance to which it belongs, and hot water is supplied to coffee extract, the coffee which is obtained on the basis of the interaction between the water and the coffee extract flows from the internal space through the at least one hole which is present in the dish-shaped portion of the accessory. On the other hand, the dish-shaped portion of the closed accessory is free from holes. In other words, the dish-shaped portion of the closed accessory can be denoted as being closed. Due to the absence of holes in the dish-shaped portion of the accessory, water which is received from the liquid supplying system cannot flow from one side of this portion to the other, but only flows over the one side.

Assuming that the closed accessory has a dish-shaped portion, it is advantageous if the accessory furthermore comprises an elongated portion extending from the dish-shaped portion. Not only can an elongated portion be used by a user for taking hold of the accessory, but such a portion can serve as an outlet of the water which is supplied to the dish-shaped portion of the accessory when the accessory is used in the appliance. In that case, there is no need for the water to be guided towards an outlet which serves for letting out coffee when the flow through accessory is used. As a result, a path to be followed by the water can be shorter, which is advantageous in few of the fact that pressures prevailing inside the appliance can be kept lower. Also, temperature loss of the water is reduced when the path is shortened. Another advantage of having separate outlets for the two different coffee making processes is that the design of each outlet can be chosen such as to be optimal for the associated coffee making process. Furthermore, the level of the outlets in the appliance can be chosen such as to be optimal for each of the possible situations, wherein the outlet can be positioned at a lower level in case of the internal brewing process, and wherein the outlet can be positioned at a higher level in case of the external brewing process. It is practical if the outlet associated with the flow through accessory, i.e. the outlet at the lower level, is part of a removable part of the appliance, so that the outlet can be omitted in the case of an external brewing process and cannot be in the way of a combination of a jug and a drip filter holder which is used in the process.

When the closed accessory has an elongated portion serving as an outlet as described in the foregoing, it is practical if the elongated portion is generally shaped like a hollow tube having at least one hole at a free end thereof. It is advantageous if the free end of the elongated portion is at a lower level than an end connected to the dish-shaped portion of the accessory when the accessory is put in place inside the internal space of the housing of the appliance to which it belongs, so that gravity may help in having an outgoing water flow through the at least one hole.

It is very practical for the appliance to comprise pumping means for pumping the liquid through the appliance, as has already been mentioned in the foregoing. Furthermore, the appliance may be equipped with controlling means for controlling the pumping means, wherein the controlling means are programmed for controlling the pumping means according to at least two different algorithms, wherein a first algorithm involves operating the pumping means during a shorter period of time and at a higher pressure than a second algorithm. When the appliance is operated, the controlling means are made to execute one of the algorithms. The first algorithm is applicable in a situation in which the flow through accessory is used with the appliance, whereas the second algorithm is applicable in a situation in which the closed accessory is used with the appliance.

The choice in favor of a certain algorithm can be communicated to the controlling means on the basis of input provided by a user of the appliance. For example, the appliance may comprise a button which can be touched/depressed by the user, wherein the way in which the button is operated determines the nature of a signal which is transmitted to the controlling means. Another possibility is that the appliance comprises detecting means for detecting whether a receptacle is put in place with respect to the appliance, for receiving a liquid from the appliance, wherein the detecting means are adapted to transmit a signal to the controlling means when a receptacle is detected, indeed, the signal representing the presence of the receptacle in that case. For example, only a jug which is intended to be used in a process of making drip filter coffee can be provided with an element which can be detected by the detecting means. In that situation, it is achieved that when the jug is put in place with respect to the appliance, the detecting means are activated to transmit a signal, as a result of which the controlling means are made to execute the second algorithm. When the appliance is activated but without the jug placed nearby, the detecting means are not activated, and the controlling means execute the first algorithm, which can be regarded as a default algorithm for that reason. In general, it can be said that it is practical when the controlling means are adapted to control the pumping means according to the second algorithm after receipt of the signal from the detecting means.

According to a practical possibility, the detecting means comprise a detector which is adapted to detect an RFID tag. Thus, in such a case, it is advantageous for a jug to be used with the appliance to be provided with an RFID tag.

The second algorithm may involve operating the pumping means during two successive periods of time, with a halt in between, wherein a first period of time is significantly shorter than a second period of time. When the closed accessory is positioned inside the internal space of the housing of the appliance and the second algorithm is executed, drip filter coffee is made by using hot water which is let out by the appliance. It is advantageous if the appliance is adapted to first deliver a batch of water, followed by a continuous flow, as in that case, it is achieved that the coffee powder which is used for making the drip filter coffee is fully moisturized before the actual coffee making process starts, which yields excellent quality and taste of the drip filter coffee. In this respect, it is preferred to use the appliance according to the invention for the purpose of making drip filter coffee over a conventional appliance for making this type of coffee, as the latter appliance normally does not comprise a pump and is therefore not capable of delivering a batch of water for moisturizing the coffee powder at the start of a coffee making process.

Preferably, the appliance comprises a flow through heater for heating the water at a position upstream of the internal space, wherein the heater is associated with the system for supplying the water to the internal space. In principle, it is possible to use a boiler for heating the water, but when a flow through heater is applied, more possibilities for setting particulars in an optimal manner for each of the possible coffee making processes are obtained. It is a well-known fact that factors like the extraction time, i.e. the time of contact between the coffee powder and the water, and the temperature of the water influence the taste of the coffee to a large extent. With a flow through heater, these factors can easily be adjusted, so that the appliance is very well capable of delivering various types of coffee at the highest possible quality, without compromise. It is noted that in case a boiler is used, it is possible to operate the boiler as a flow through boiler when desired, which means that it is possible to continuously pump water at a relatively low flow rate after heating the water in the boiler, instead of dosing the water in a batch. An example of a relatively flow rate is a flow rate which is in a range of 2 to 3 ml/s.

The present invention relates to the appliance for making a beverage as described in the foregoing. Furthermore, the present invention relates to a device which is intended to be used as an accessory of an appliance for making a beverage, wherein a substantial portion of the device is generally shaped like a dish, and free from holes. In other words, the present invention also relates to a practical embodiment of the closed accessory, which has a unique design adapted to allow hot water to flow directly towards an outlet so that the water can be used in a process of making drip filter coffee, without unnecessary temperature and/or pressure losses. In conformity with the explanation already provided in respect of the closed accessory, it is noted that it is advantageous for the accessory to furthermore comprise an elongated portion extending from the dish-shaped portion, as such an elongated portion may serve as an outlet when the accessory is put in place in the appliance. Hence, on the basis of the presence of the elongated portion, there is no need for the water to follow a path through the appliance which is optimized for an internal brewing process. Instead, the water can follow a short-cut which is optimized for an external brewing process. The elongated portion may be shaped like a kind of discharge tube, i.e. a hollow tube having at least one hole at a free end thereof.

The above-described and other aspects of the present invention will be apparent from and elucidated with reference to the following detailed description of a coffee maker which is suitable to be used for making pod-based coffee and drip filter coffee, depending on a choice of a user, and which comprises two different types of removable accessories.

### BRIEF DESCRIPTION OF THE DRAWINGS

The present invention will now be explained in greater detail with reference to the figures, in which equal or similar parts are indicated by the same reference signs, and in which:

FIG. 1 shows an exploded view of a coffee maker according to the present invention, with two removable accessories according to a first type;

FIG. 2 shows a perspective view of an accessory according to the first type;

FIG. 3 shows a top view of an accessory according to the first type;

FIG. 4 shows a perspective view of an accessory according to a second type, which is suitable to be used with the coffee maker;

FIG. 5 shows a sectional view of an accessory according to the second type;

FIG. 6 shows a perspective view of the coffee maker, with an accessory of the second type put in place, and with a combination of a jug and a drip filter holder positioned such as to receive hot water from the coffee maker; and

FIG. 7 shows a perspective view of the combination of the jug and the drip filter holder, with a cover of the drip filter holder removed.

### DETAILED DESCRIPTION OF EMBODIMENTS

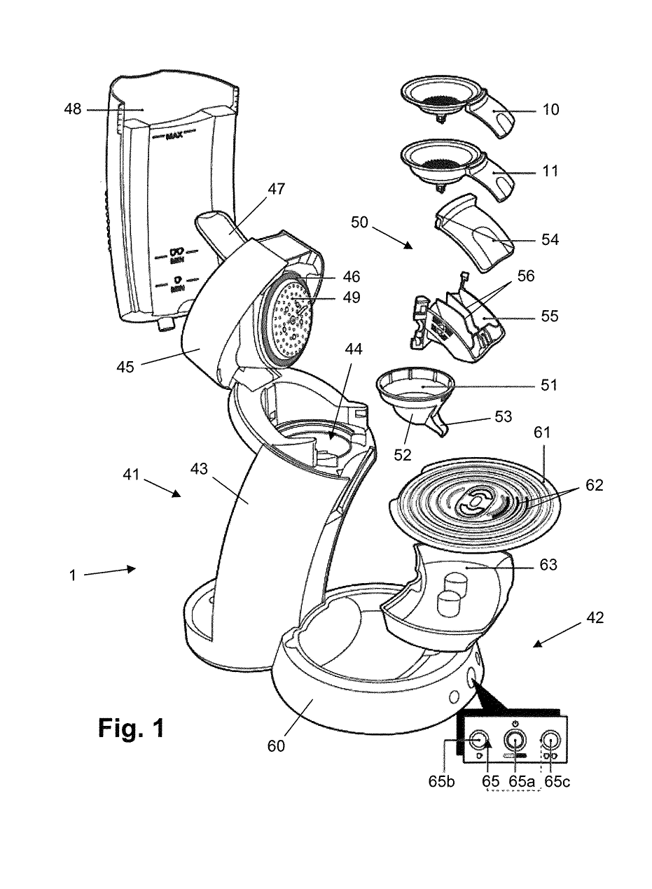

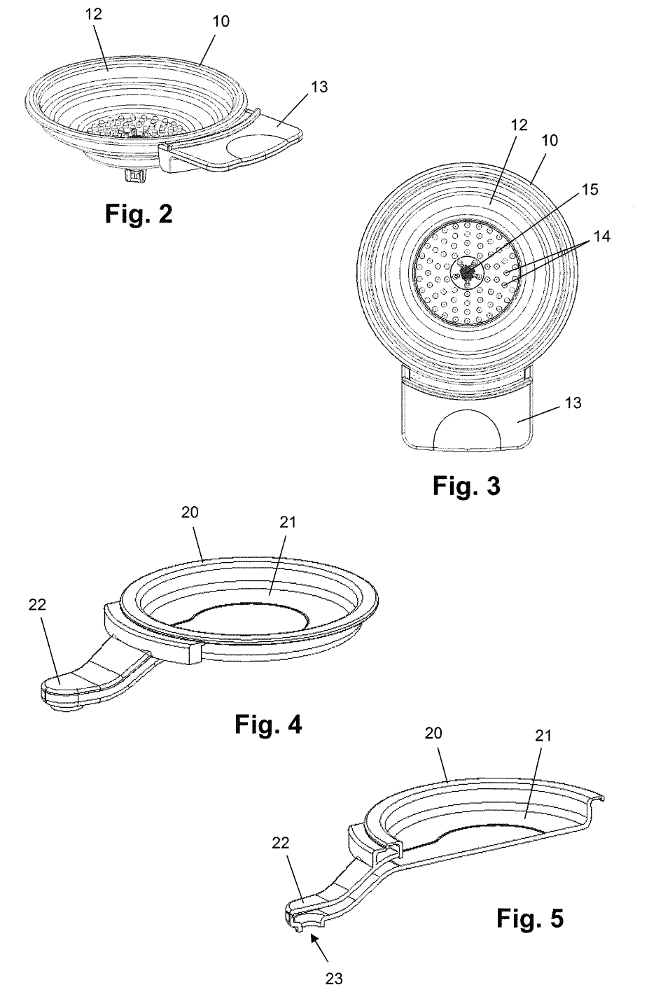

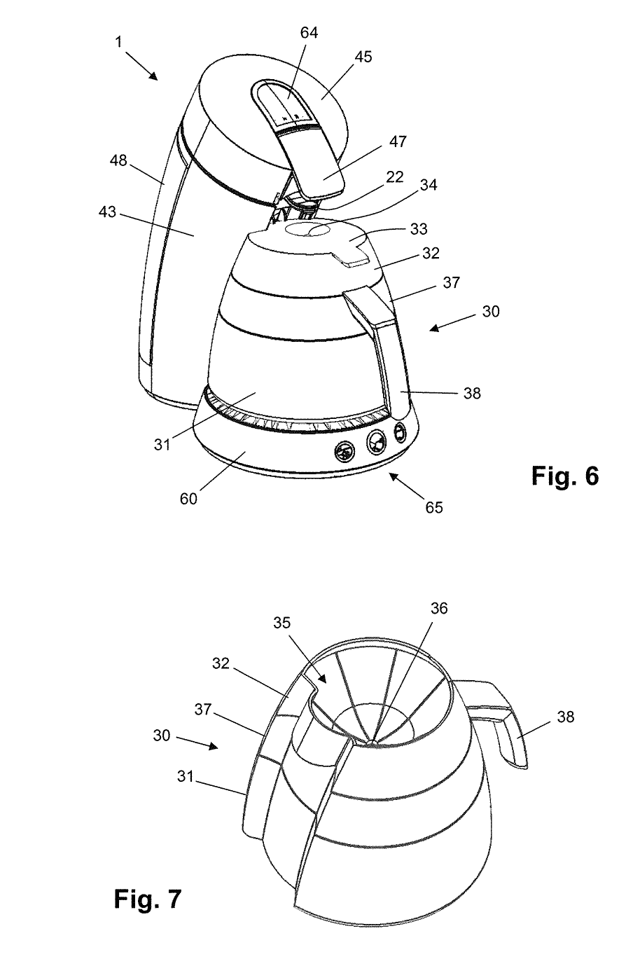

FIG. 1 shows a coffee maker 1 according to the present invention, with two removable accessories 10, 11 according to a first type, which are referred to as flow through accessories 10, 11. A flow through accessory 10 is also shown in FIGS. 2 and 3. FIGS. 4 and 5 show a removable accessory 20 of a second type, which is referred to as closed accessory 20. FIG. 6 shows the coffee maker 1 with a closed accessory 20 put in place, and with a combination 30 of a jug 31 and a drip filter holder 32 positioned such as to receive hot water from the coffee maker 1. FIG. 7 shows the combination 30 of the jug 31 and the drip filter holder 32, with a cover 33 of the drip filter holder 32 removed, so that the inside of the drip filter holder 32 can be seen.

FIG. 1 illustrates the fact that in general, the coffee maker 1 comprises two interconnected parts 41, 42. A first part 41 has a housing 43 in which various components of the coffee maker 1 are accommodated, such as a pump, a flow through heater and a microcontroller. The housing 43 has an internal space 44, which is adapted to receive and accommodate one of the accessories 10, 11, 20 of the coffee maker 1. A cover 45 is hingeably connected to the housing 43 and serves for closing the internal space 44 in a closed position, and for allowing access from outside to the internal space 44 in an opened position. For sake of clarity, it is noted that the opened position of the cover 45 is illustrated in FIG. 1. In order to be capable of realizing a liquid-tight closed status of the internal space 44, the cover 45 is provided with a sealing ring 46, which is adapted to constitute a barrier such that liquid cannot pass between an accessory 10, 11, 20 positioned inside the internal space 44 and the cover 45 when the cover 45 is in the closed position.

The coffee maker 1 is adapted to make coffee in at least two different ways. A first way of coffee making involves using at least one pod filled with coffee powder and supplying hot water to the pod. In the process, the water is forced to flow through the pod. On the basis of interaction between the water and the coffee powder, coffee is obtained. In respect of the pod, it is noted that this may be a disposable pod, comprising a predetermined quantity of coffee powder enclosed in a filter envelope, or, for example, a refillable pod having a plastic frame and filter portions arranged in the frame, wherein the frame comprises two parts which are hingeably connected to each other, such that an opened position and a closed position of the frame can be realized by moving the parts apart and towards each other.

The process of making pod-based coffee takes place inside the coffee maker 1, in the internal space 44 of the housing 43. The coffee maker 1 is suitable to be used for extracting one coffee pod or two coffee pods at a time. In order to insert one coffee pod in the coffee maker 1, a user of the coffee maker 1 takes one of the flow through accessories 10, 11, particularly the accessory 10 which is shown at the top of FIG. 1, and places the coffee pod in a dish-shaped portion 12 of the accessory 10, while holding the accessory 10 by means of a handle portion 13. The dish-shaped portion 12 of the flow through accessory 11 which is shown at a lower level in FIG. 1 is deeper, and therefore, the flow through accessory 11 is suitable for supporting two coffee pods positioned on top of each other. Apart from that, the design of the two flow through accessories 10, 11 is generally the same. When the at least one coffee pod is in place on the appropriate flow through accessory 10, 11, the user inserts the combination of the accessory 10, 11 and the pod in the internal space 44 of the housing 43 of the coffee maker 1. Naturally, this can only be done when the cover 45 is in the opened position as shown in FIG. 1. After insertion of the combination of the accessory 10, 11 and the pod, the user puts the cover 45 in the closed position. In order to lock the cover 45 in this position, the user pulls down a handle 47 which is present on top of the cover 45.

The coffee maker 1 comprises a system for supplying water at a certain temperature and a certain pressure to the internal space 44, so that the coffee making process can take place in a suitable manner. In the first place, the coffee maker 1 is equipped with a water container 48, which is removably arranged with respect to the housing 43, so that a user can easily take care of a refill of the water container 48 if necessary. When the water level inside the water container 48 is sufficiently high, the pump can be activated in order to realize a displacement of an appropriate quantity of water from the water container 48 to the internal space 44. In the process, the water passes the flow through heater, so that the temperature of the water is increased to a desired level. The pressure that is necessary for forcing the hot water to flow through the at least one coffee pod is provided by means of the pump.

For the purpose of letting in the hot water to the internal space 44, a spray head 49 is arranged at a bottom side of the cover 45, which is connected to the water container 48 through suitable tubing or the like. Hence, the water is supplied to the internal space 44 from the top. For sake of completeness, it is noted that the orientation of the coffee maker 1 as shown in FIG. 1 is a normal orientation, and that a term like “top” should be understood with reference to that orientation.

For the purpose of letting out the pod-based coffee from the internal space 44, the coffee maker 1 comprises a number of components forming an outlet assembly 50. In the first place, an outlet element 51 comprising a dish-shaped portion 52 and an elongated outlet gutter 53 projecting outwardly and downwardly from the dish-shaped portion 52 is used. The dish-shaped portion 52 of this element 51 fits inside the internal space 44, at a bottom side of the space 44. The housing 43 is provided with an opening for allowing the outlet gutter 53 to project from the housing 43 when the outlet element 51 is put in place inside the coffee maker 1. Furthermore, the coffee maker 1 comprises two elements 54, 55 for covering the outlet gutter 53 of the outlet element 51 at a bottom side and a top side. A bottom cover element 55 is provided with baffles 56 for guiding the coffee towards holes for letting out the coffee, which holes are present between the cover elements 54, 55 when these elements 54, 55 are placed against each other, such as to cover the outlet gutter 53 of the outlet element 51 from both sides, and are snapped together in order to have a proper connection.

The coffee maker 1 supplies pod-based coffee in quantities which are suitable for filling one or two small cups, or one large cup. The at least one cup should be placed in such a position that the coffee can flow down from the outlet assembly 50 to the cup. A second part 42 of the coffee maker 1 is suitable for supporting the cup, and comprises a removable supporting plate 61 having holes 62. Underneath the supporting plate 61, a drip tray 63 is arranged for receiving spilt coffee, which is also removable in order to allow a user to empty the drip tray 63 and clean the drip tray 63 if so desired. The second part 42 of the coffee maker 1 comprises a base 60 for accommodating the drip tray 63 and supporting the supporting plate 61.

When a user wants the coffee maker 1 to initiate a process for making pod-based coffee, the user can provide appropriate input to the microcontroller. Depending on the input provided by the user, the microcontroller selects an algorithm for operating the pump and the flow through heater in order to supply an appropriate quantity of water to the internal space 44 at an appropriate pressure and an appropriate temperature. For example, a number of buttons 65 can be provided for allowing the user to communicate with the microcontroller. Such buttons 65 can also be used for switching on the coffee maker 1, and switching off the coffee maker 1. It may be so that three buttons 65 are provided, wherein one 65a of the buttons 65 is suitable to be used as an on/off switch, wherein another 65b of the buttons 65 is suitable to be used for initiating a process for brewing coffee by using one pod, and wherein yet another 65c of the buttons 65 is suitable to be used for initiating a process for brewing coffee by using two pods. However, it should be understood that a different configuration of buttons 65 is possible, in case buttons 65 are used in the coffee maker 1. FIG. 1 shows how the buttons 65 can be positioned in the base 60, which does not alter the fact that the buttons 65 may just as well be present at another position in the coffee maker 1, including a position on the cover 45.

A flow through accessory 10 for supporting one coffee pod is shown in more detail in FIGS. 2 and 3. In the dish-shaped portion 12 of the accessory 10, studs 14 are present in order to have space underneath a coffee pod when such a pod is places on the accessory 10. During the coffee making process, the coffee flows through the space and exits the accessory 10 through a central hole 15.

The coffee maker 1 is also suitable to be used for making drip filter coffee. To this end, the coffee maker 1 comprises a closed accessory 20 as shown in FIGS. 4 and 5. The closed accessory 20 comprises a dish-shaped portion 21 and an elongated outlet portion 22 projecting from the dish-shaped portion 21. Contrary to the dish-shaped portion 12 of the flow through accessories 10, 11, the dish-shaped portion 21 of the closed accessory 20 does not have a central hole. The outlet portion 22 is hollow and has at least one hole 23 at it free end. In this way, the outlet portion 22 is adapted to effectively discharge a liquid from the dish-shaped portion 21, wherein all of the liquid is made to flow through this portion 22. The size of the hole 23 can be optimized for having an appropriate pressure of the water to be discharged.

When a user decides to use the coffee maker 1 for making drip filter coffee, he/she needs to use the closed accessory 20 instead of one of the flow through accessories 10, 11. Furthermore, he/she may remove the outlet assembly 50 from the coffee maker 1. When the closed accessory 20 is put in place inside the internal space 44, and the cover 45 is closed, water which is supplied through the spray head 49 is received directly in the dish-shaped portion 21 of the accessory 20, and is discharged through the outlet portion 22 of the accessory 20. In the process, the sealing ring 46 which is present at the bottom side of the cover 45 constitutes a barrier such that liquid cannot pass between the accessory 20 and the cover 45.

In order to have a process of making drip filter coffee, a drip filter filled with coffee powder needs to be used, and needs to be positioned such as to be capable of receiving hot water from the outlet portion 22 of the closed accessory 20. FIG. 6 illustrates how a combination 30 of a jug 31 and a drip filter holder 32 can be present on top of the supporting plate 61 of the coffee maker 1 in order for the drip filter accommodated by the drip filter holder 32 to be in the correct position as mentioned. When the discharge assembly 50 is removed, indeed, it is achieved that it is not in the way of the combination 30 of the jug 31 and the drip filter holder 32, which is higher than a cup for receiving pod-based coffee from the coffee maker 1. The volume of the water container 48 of the coffee maker 1 is large enough for making sure that the jug 31 can be filled to an acceptable extent. Suitable means may be provided which enable a user to provide information regarding a desired quantity of drip filter coffee to the microcontroller.

Preferably, the jug 31 is provided with an RFID tag or another recognition code, and the coffee maker 1 is provided with means which are capable of detecting the RFID tag. In this way, it can be achieved that a user's intention to have a drip filter coffee making process is automatically communicated to the microcontroller, so that the appropriate algorithm may automatically be initiated. Another advantage resides in the fact that unintended use of the drip filter coffee algorithm may be avoided. It is noted that alternative means for detecting the presence of the jug 31 are feasible within the scope of the present invention. For example, mechanical means may be applied, such as a cam pushing on a micro-switch. Also, the drip filter holder 32 may be provided with a recognition code instead of the jug 31, or may be suitable for touching mechanical means when put in the right position.

Automatic recognition of the presence of a combination 30 of a jug 31 and a drip filter holder 32 is not essential within the scope of the present invention. In principle, it is very well possible that a button or the like is provided by means of which a user can provide a signal to the microcontroller representing a wish to have the microcontroller execute the drip filter coffee algorithm. The button may be one of the buttons 65 which are already present in the coffee maker 1 for the purpose of providing input relating to a pod-based coffee making process, wherein a specific way of operating the button, for example, depressing the button two times with a very short intermediate period of time, may represent the desire for another type of coffee making process. For sake of completeness, it is noted that the coffee maker 1 may comprise a display 64 which can be used for providing information to the user, including information regarding the type of coffee making process, as shown in FIG. 6.

When the algorithm for making drip filter coffee is executed, the pump is operated in such a way that the pressure is significantly lower than in case of a process for making pod-based coffee. Furthermore, the pump is operated during a longer period of time, in order to have a more or less continuous flow of water. Also, the flow through heater is operated in a different manner, such as to realize a supply of hot water at an appropriate temperature, throughout the entire coffee making process. Due to the fact that hot water is guided along a short path from the spray head 49 to the combination 30 of the jug 31 and the drip filter holder 32 by means of the closed accessory 20, temperature loss of the water is at a minimum.

For example, in a process of making pod-based coffee, the pressure may be in an order of 1.4 bar, and a flow rate of the water/coffee may be about 5.6 ml/s. The values of the pressure and flow rate are mainly determined by the restriction in the system for transporting liquid through the coffee maker 1, which is constituted by the flow through accessory 10. In particular, the size of the hole 15 in the flow through accessory 10 is an important factor in this respect. The volume of liquid to be displaced in the process can be based on a certain time of operation of the pump. In a process of making drip filter coffee, pressure is near ambient pressure, due to the application of the closed accessory 20. One way of achieving a flow rate which is normal in the field of making drip filter coffee, such as a flow rate of about 2 to 3 ml/s, involves electronically squeezing the pump. The volume of liquid to be displaced in the process can be determined in a way which is known from the field of making drip filter coffee. In particular, it is possible to have an indicator of a number of cups on the water container 48. In that case, a user should take care that the water container 48 is filled with the appropriate quantity of water before the drip filter coffee making process starts. The pump can then be activated until the water container 48 is empty. Termination of operation of the pump can take place in a manner known per se, on the basis of a signal representing an empty state of the water container 48, wherein suitable means are provided for detecting such state.

The drip filter coffee algorithm may involve a step of delivering a relatively small batch of water at the start of the coffee making process. This batch of water can be used for realizing that the coffee powder inside the drip filter is moisturized first, which contributes to good taste of the coffee which will be obtained.

Conventionally, the drip filter holder 32 can have a cover 33 as shown in FIG. 6. Naturally, such a cover 33 has an opening 34 for letting through the water to an internal space 35 of the drip filter holder 32, where the drip filter is arranged and the actual coffee making process takes place. The internal space 35 as mentioned can be seen in FIG. 7. At a bottom side of the drip filter holder 32, a central hole 36 is present for allowing coffee to flow from the drip filter to the jug 31. The jug 31 may be a thermos jug 31, so that temperature loss of the coffee can be kept at a minimum.

The drip filter holder 32 is removably arranged with respect to the jug 31. Advantageously, the jug 31 has a cover 37 which can be closed as soon as the drip filter holder 32 is removed. Such a cover 37 may be a separate component. The jug 31 has a handle 38, so that it is easy for a user to pick up the jug 31 and poor coffee out of the jug 31.

It is possible for the combination of the jug 31 and the drip filter holder 32 to be designed in such a way that the jug 31 can be removed from the coffee maker 1 while the drip filter holder 32 stays in place with respect to the coffee maker 1. For example, the drip filter holder 32 can be suitable for attachment to the outlet assembly 50, if not removed during a drip filter coffee making process, or to another component of the coffee maker 1. Also, the outlet portion 22 of the closed accessory 20 may be separate from the other components of the accessory 20, and may be integrated with the drip filter holder 32.

When the present invention is applied, a coffee maker 1 which is suitable for making coffee by means of a process taking place inside of the coffee maker 1, such as a process of making pod-based coffee, can also be used for making coffee by means of a process taking place outside of the coffee maker 1, such as a process of making drip-filter coffee. In the latter case, the coffee maker 1 does not emit coffee during operation, but hot water. A user does not need to do much more than making sure that a correct type of accessory 10, 11, 20 is used, and that corresponding input is provided to the microcontroller of the coffee maker 1, if this input is not communicated automatically. Each of the accessories 10, 11, 20 is adapted to be positioned in the same internal space 44 of the housing 43 of the coffee maker 1. Hence, the solution according to the present invention for having a coffee maker 1 capable of making two different types of coffee is very user-friendly, as the user does not need to perform complex actions and can act more or less the same in all possible situations, according to routine. Furthermore, the user does not need to have two separate appliances for making the different types of coffee, so that space is saved in the kitchen, and the user is not compelled to take appliances from a cupboard, move appliances etc. when a switch is made to having another type of coffee.

It is noted that when an attempt is made to adjust a coffee maker 1 which is suitable for making pod-based coffee in such a way that it is also capable of making drip filter coffee by using a kind of pod which is positioned inside the coffee maker 1, no good results are to be expected. The type of coffee powder used for making drip filter coffee is not suitable to be extracted under pressure during a short period of time. Moreover, the internal space 44 of the housing 43 of the coffee maker 1 is not large enough for accommodating a quantity of coffee powder which is suitable for making enough coffee for filling an entire jug 31. It is an achievement of the present invention that a solution is found in extending the water supplying system 48, 49 of the coffee maker 1, as it were, by providing a new type of accessory 20 to be used with the coffee maker 1, and controlling the coffee maker 1 in such a way that an optimal setting of parameters in a process of making drip filter coffee is realized.

It will be clear to a person skilled in the art that the scope of the present invention is not limited to the examples discussed in the foregoing, but that several amendments and modifications thereof are possible without deviating from the scope of the present invention as defined in the attached claims. While the present invention has been illustrated and described in detail in the figures and the description, such illustration and description are to be considered illustrative or exemplary only, and not restrictive. The present invention is not limited to the disclosed embodiments.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

The present invention can be summarized as follows. An appliance 1 which is suitable to be used for making a beverage in at least two different ways comprises at least two different types of removable accessories 10, 11, 20, a housing 43 having an internal space 44 for receiving and accommodating one of the accessories 10, 11, 20 at a time, and a liquid supplying system 48, 49 for supplying a liquid to the internal space 44. In a practical embodiment of both types of accessories 10, 11, 20, a substantial portion 12, 21 of the accessory 10, 11, 21 is generally shaped like a dish, wherein the dish-shaped portion 12 of a first type of accessory 10, 11 comprises at least one hole 15 for allowing liquid to pass the dish-shaped portion 12 and flow from one side of the dish-shaped portion 12 to the other, and wherein the dish-shaped portion 21 of a second type of accessory 20 is free from holes. The second type of accessory 20 is therefore suitable to be used for receiving liquid from the supplying system 48, 49 and guiding this liquid directly to outside of the appliance 1.

1. Appliance which is suitable to be used for making a beverage in at least two different ways, comprising at least two different types of removable accessories, a housing having an internal space for receiving and accommodating one of the accessories at a time, and a liquid supplying system for supplying a liquid to the internal space, wherein a first type of accessory is arranged to support a beverage extract the first type of accessory is adapted to let the liquid pass from a side of the accessory, supporting the beverage extract at which the liquid is received from the liquid supplying system when the accessory is put in place inside the internal space to another side of the accessory along with the beverage before exiting the internal space,
and characterized in that a second type of accessory is adapted to let the liquid flow directly out of the internal space without interacting with a beverage extract before exiting the internal space.

2. Appliance according to claim 1, wherein the accessory according to the second type is adapted to only let the liquid flow over the accessory at a side at which the liquid is received from the liquid supplying system when the accessory is put in place inside the internal space.

3. Appliance according to claim 1, wherein it is true for both types of accessories that a substantial portion of the accessory is generally shaped like a dish, wherein the dish-shaped portion of the first type of accessory comprises at least one hole for allowing liquid to pass the dish-shaped portion and flow from one side of the dish-shaped portion to the other, and wherein the dish-shaped portion of the second type of accessory is free from holes.

4. Appliance according to claim 3, wherein the accessory according to the second type furthermore comprises an elongated portion extending from the dish-shaped portion.

5. Appliance according to claim 4, wherein the elongated portion is generally shaped like a hollow tube having at least one hole at a free end thereof.

6. Appliance according to claim 1, comprising pumping means for pumping the liquid through the appliance, and controlling means for controlling the pumping means, wherein the controlling means are programmed for controlling the pumping means according to at least two different algorithms, wherein a first algorithm involves operating the pumping means during a shorter period of time and at a higher pressure than a second algorithm.

7. Appliance according to claim 6, comprising detecting means for detecting whether a receptacle is put in place with respect to the appliance, for receiving a liquid from the appliance, wherein the detecting means are adapted to transmit a signal to the controlling means when a receptacle is detected, indeed, the signal representing the presence of the receptacle in that case.

8. Appliance according to claim 7, wherein the detecting means comprise a detector which is adapted to detect an RFID tag.

9. Appliance according to claim 7, wherein the controlling means are adapted to control the pumping means according to the second algorithm after receipt of the signal from the detecting means.

10. Appliance according to 6, wherein the second algorithm involves operating the pumping means during two successive periods of time, with a halt in between, wherein a first period of time is significantly shorter than a second period of time.

11. Appliance according to claim 1, comprising a flow through heater for heating the liquid at a position upstream of the internal space, wherein the heater is associated with the liquid supplying system.

12. (canceled)

13. (canceled)

14. (canceled)

15. (canceled)

16. A closed accessory for use as the second accessory in an appliance according to claim 1.
